(19) United States
(12) Patent Application Publication
(10) Pub. No.: US 2008/0305764 A1
(43) Pub. Date: Dec. 11, 2008

(54) SYSTEM FOR MANAGING A SCOPE OF COMMUNICATIONS OF A COMMUNICATION DEVICE

(75) Inventors: EDWARD WALTER, BOERNE, TX (US); LARRY B. PEARSON, SAN ANTONIO, TX (US)

Correspondence Address: AKERMAN SENTERFITT, P.O. BOX 3188, WEST PALM BEACH, FL, 33402-3188, US

(73) Assignee: AT&T KNOWLEDGE VENTURES, LP, RENO, NV (US)

(21) Appl. No.: 11/761,089

(22) Filed: Jun. 11, 2007

(51) Int. Cl. H04M 11/00; H04M 11/10

(52) U.S. Cl. 455/405; 455/413

(57) ABSTRACT

A system for managing a scope of communications of a communication device is disclosed. A system that incorporates teachings of the present disclosure may include, for example, communication device having a controller element to receive one or more entries in a contact book of a second communication device, and limit a scope of communications with other communication devices according to the one or more contact book entries received. Additional embodiments are disclosed.

### FIELD OF THE DISCLOSURE

The present disclosure relates generally to communication systems, and more specifically to a system for managing a scope of communications of a communication device.

### BACKGROUND

With affordable prices for cell phones and cellular services, it is now common for parents to buy their children cell phones. Some parents choose to give their children a cell phone for security reasons. Cell phones can also be helpful to parents with children involved in multiple after-school activities.

It is not uncommon, however, for young children and teenagers to misuse these services. A need therefore arises for a system for managing a scope of communications of a communication device.

### BRIEF DESCRIPTION OF THE DRAWINGS

FIG. 1 depicts an exemplary embodiment of a communication system;

FIG. 2 depicts an exemplary embodiment of a communication device operating in the communication system;

FIGS. 3-4 depict exemplary methods operating in portions of the communication system;

FIG. 5 depicts an exemplary illustration of a shared contact book;

FIG. 6 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a system for managing a scope of communications of a communication device.

In a first embodiment of the present disclosure, a computer-readable storage medium in a communication device can have computer instructions for creating a contact book with a plurality of entries in the communication device, classifying a portion of the plurality of entries of the contact book for use by a second communication device, and submitting to the second communication device the portion of the plurality of entries of the contact book, wherein a scope of communications of the second communication device is limited to the portion of the plurality of entries of the contact book.

In a second embodiment of the present disclosure, a first communication device can have a controller element to receive one or more entries in a contact book of a second communication device, and limit a scope of communications with other communication devices according to the one or more contact book entries received.

In a third embodiment of the present disclosure, a voicemail system can have a controller element to record one or more voicemail messages based on a call redirected from an unresponsive first communication device having a limited scope of communications with other communication devices defined by a portion of a contact book of a second communication device supplied to the first communication device.

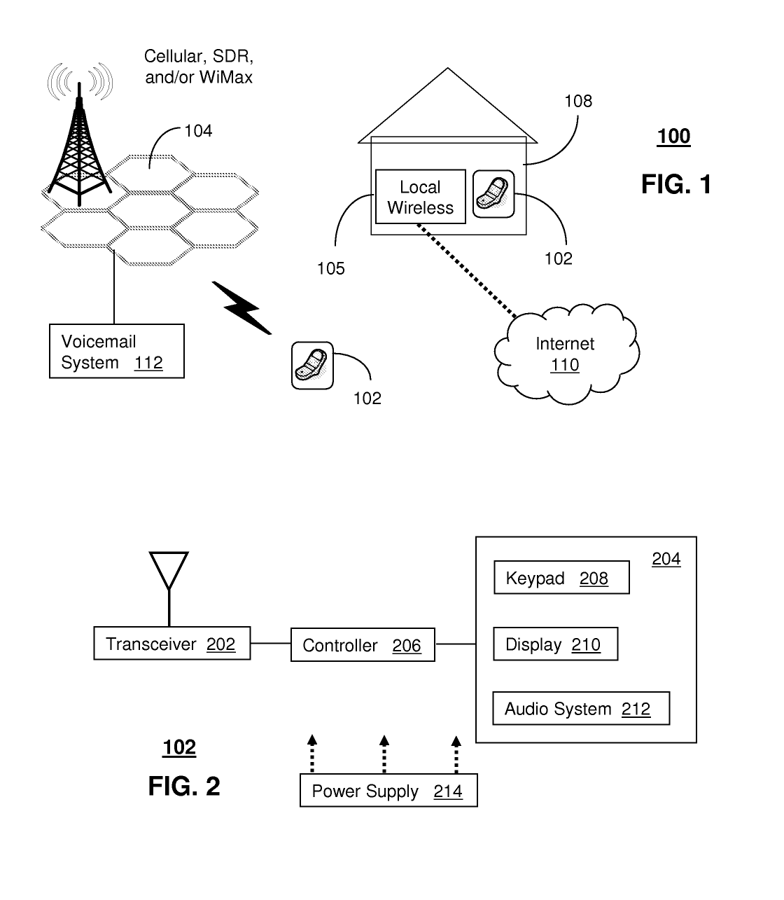

FIG. 1 depicts an exemplary embodiment of a communication system 100. The communication system 100 can comprise a plurality of communication devices 102 roaming in the communication system 100. The communication device 102 in the present illustration can represent a device capable of communicating with any number of access technologies operating in a base station 104 such as, for example, cellular, software defined radio (SDR) and/or WiMAX technologies, just to mention a few. Cellular technologies can include, for example, CDMA-1X, UMTS/HSDPA, GSM/GPRS, TDMA/EDGE, EV/DO, and next generation technologies as they arise. While in close proximity, the communication device 102 can also communicate in a building 108 with a local wireless access point 105 utilizing WiFi or Bluetooth communication technologies. The access point 105 in turn can be coupled to the Internet 110 by common means (e.g., xDSL or cable) to provide Voice over IP (VoIP) services as well as broadband data to the communication device 102.

The communication system 100 can further comprise a voicemail system 112 for recording voicemail messages in instances when a calling party is unable to reach a user of the communication device 102. The voicemail system 112 can utilize common technology for accepting a call from a calling party, presenting a greeting and instructive call processing options by way of an interactive voice response system that assists the calling party in recording a voicemail message. The voicemail system 112 can also transmit by way of the base station 104 or by wireline access to the local wireless access point 105 voicemail notices to the communication device 102 when a voicemail message has been recorded.

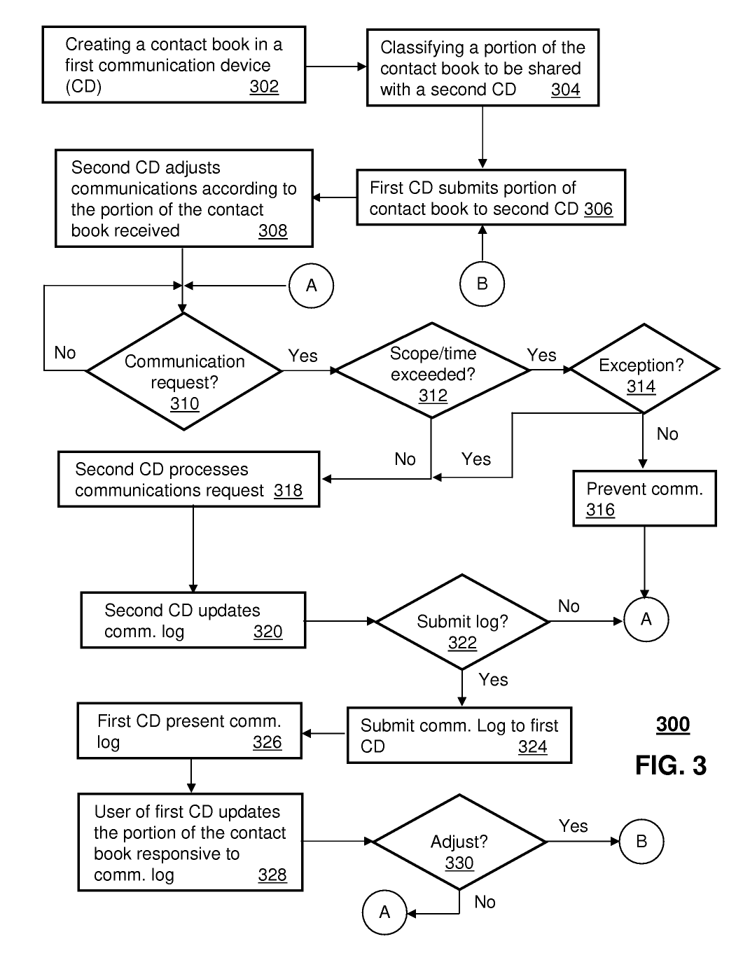

FIG. 2 depicts an exemplary embodiment of the communication device 102. The communication device 102 can comprise a wireless transceiver 202, a user interface (UI) 204, a power supply 214, and a controller 206 for managing operations thereof. The wireless transceiver 202 utilizes common communication technology that supports the aforementioned access technologies (i.e., cellular, SDR, WiMAX and WiFi). The UI 204 can include a depressible or touch-sensitive keypad 208 for manipulating operations of the communication device 102. The UI 204 can further include a display 210 such as monochrome or color LCD (Liquid Crystal Display) for conveying images to the end user of the communication device 102. The audio system 212 of the UI 204 utilizes common audio technology for conveying and intercepting audible signals of the end user.

The power supply 214 can utilize common power management technologies (such as replaceable batteries, supply regulation technologies, and charging system technologies) for supplying energy to the components of the communication device 102 to facilitate portable applications. The controller 206 can utilize computing technologies such as a microprocessor and/or digital signal processor (DSP) with associated storage memory such a Flash, ROM, RAM, SRAM, DRAM or other like technologies.

Possible embodiments for the communication device 102 include without limitation a cell phone, a personal digital assistant (PDA), or portable computer capable of wirelessly communicating with the base station 104, or the local wireless access point 105. The communication device 102 can also be tethered by a cable to a wireline access point (e.g., xDSL, POTS interface) to engage in voice and/or data communications.

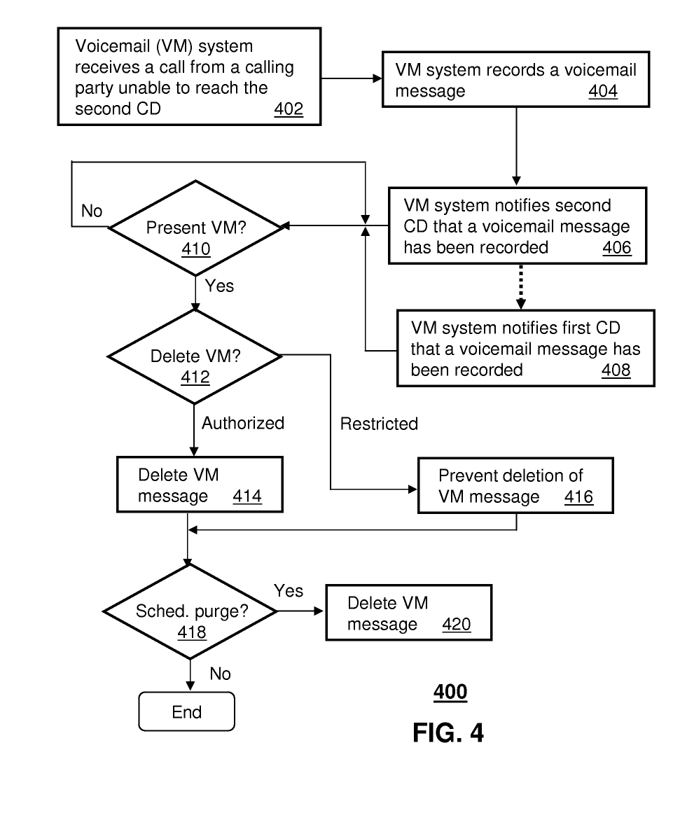

FIGS. 3-4 depict exemplary methods 300-400 operating in portions of the communication system 100. Method 300 depicts a means to control the scope of communications of a communication device 102. This method can be applied by a parent who desires to manage the scope of communications of a young child or teenager's communication device 102. Method 400 illustrates a means to manage a voicemail account of the communication device 102 of the young child or teenager.

Beginning with method 300, step 302 describes a process for creating a contact book in a first communication device (CD) 102. The first CD 102 for illustration purposes is considered to be the CD of the parent. The creation of the contact book can be accomplished by common means as illustrated by prior art cell phones, computers (e.g., Outlook™), or PDAs (e.g. PocketPC™). In step 304, the user of the first CD 102 can classify a portion of entries in the contact book to be shared with a second CD 102. The second CD 102 for illustration purposes represents a CD supplied by the parent to the child or teenager.

The contact book can have a number of common fields such as a party's name and a number of communication identifiers associated therewith. The communication identifiers can be for example a home telephone number, an office number, a cell phone number, a fax number, one or more email addresses, one or more instant messaging addresses, and/or one or more Internet addresses. The contact book can be supplemented with a sharing field which the parent can use to identify who the contact book is to be shared with, and a preference field for defining a communication preference established by the parent.

The first field can be presented as a pull down menu shown as a graphical user interface (GUI) in display 210 that depicts a number of parties to choose from (child 1, child 2, etc.). For example, in the case of a family with two or more children, the pull down menu can be the names of each child given a CD 102. A child can be identified in another entry of the contact book that has a field which can be populated to identify the child as a subordinate of the parent. All contact book entries populated in this way can be presented in the pull down menu of the sharing field mentioned above.

The communication preference of the preference field can be used to limit the scope of communication functions of the second CD 102 (e.g., child's CD) sharing a portion of the contact book of the first CD 102 (i.e., parent CD). In one embodiment, the communication preference can direct the second CD 102 to only receive messages associated with the communication identifiers of a party in a select contact book entry. In other embodiment, the communication preference can direct the second CD 102 to only transmit messages to the communication identifiers of the party in a select contact book entry. In another embodiment the communication preference can enable the second CD 102 to transmit or receive communication requests from any of the communication identifiers of a select party in the contact book. The communication preference can also determine a schedule for enabling communications. For example, a particular contact book entry may have an active communication period between 8 AM and 5 PM, Monday through Friday. For all other periods, communications is inactive for this contact book entry.

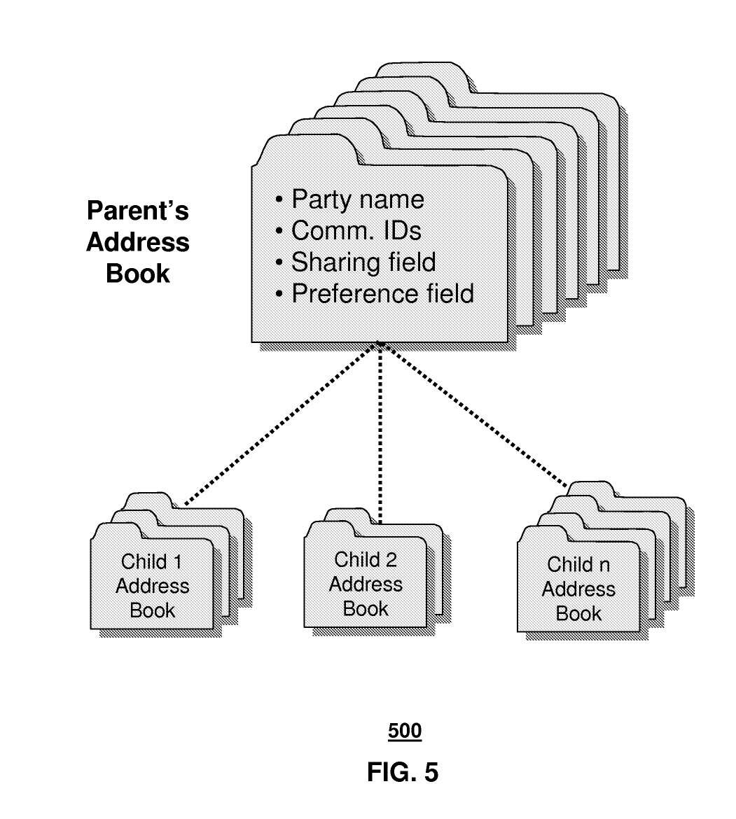

With these principles in mind, the first CD 102 can proceed to step 304 where it classifies a portion of the contact book to be shared with the second CD 102 as directed by the user of the first CD (i.e., the parent). Entries of the contact book can be marked by populating the sharing field as previously noted. Entries without a designated shared party can default to a no-sharing state. For each of the entries designated to be shared, the communication preference can default to two-way communications or one-way communications as selected by the party of the first CD 102. FIG. 5 illustrates how the classifications made by the parent in step 304 can result in a partial sharing of the parent's contact book with one or more children of the parent.

In step 306, the first CD 102 submits to the second CD the portion of the contact book classified as a shared portion in step 304. The portion of the contact book can be transmitted wirelessly over the local wireless access point 105, the base station 104, and/or the Internet 110. Said portion of the contact book can be transmitted in any format such as for example an SMS or MMS message in binary or ASCII format. In step 308, the second CD 102 can adjust its communication parameters depending on the preference field in a contact book entry being processed by said CD.

Accordingly, for a particular contact book entry the communication preference could indicate that the second CD 102 can only respond to communications (e.g., receive calls or emails). In another contact book entry, the communication preference could indicate that the second CD 102 can only initiate communication sessions (e.g., invoke calls, send emails, or browse certain websites). In other contact book entries, the communication preference of each entry could indicate that the second CD 102 can respond to or initiate communications with all the communication identifiers listed in the entry.

In step 310, the second CD 102 monitors for a communication event. A communication event can correspond to an incoming communication request or an outgoing communication request initiated by the user of the second CD 102. If there is no activity, the second CD 102 continues the monitoring process in step 310. If an event is detected for a select entry in the partial contact book, the second CD 102 proceeds to step 312 where it determines whether the scope of communication and/or the time at which the communication activity is detected is within the bounds of the communication preference defined for said entry. For example, if a contact book entry is selected by a user of the second CD 102 to call to the party named in the selected entry, the second CD 102 can check in step 312 whether the communication preference allows outgoing calls for the communication identifier selected for said entry, and whether the time of day chosen is acceptable.

If outgoing calls are allowed and the time of day is in compliance with a given schedule for said contact book entry, then the second CD 102 proceeds to step 318 where it processes the call. Otherwise, if outgoing calls are not allowed or the time of day is not within a preferred schedule, then the second CD 102 proceeds to step 314 where it checks for exceptions. An exception can be given for example to make an emergency call. The emergency call can be a standard 911 call, or a special DTMF sequence included with the select communication identifier (e.g., dial number with “*#” at the end). If such an exception is given, the second CD 102 proceeds to step 318 to process the call. Otherwise, the call is prevented in step 316 with an error message conveyed to the user by way of UI 204 indicating the call was prevented. From step 316 the second CD 102 proceeds to step 310 to monitor for additional communication activity. Steps 310 through 318 can be applied also for incoming communication requests (e.g., incoming calls, emails, or instant messaging requests).

Assuming the call is processed in step 318, the second CD 102 updates a communication log in step 320. The communication log can identify the communication identifier selected from a contact book entry, the party associated with the entry, the time of day the call was made or received, the period of communication, and whether exceptions were applied by the user (e.g., “*#” example above) or by default (e.g., 911). In step 322, the second CD 102 can be programmed to determine of the communication log needs to be submitted to the first CD 102 (i.e., the parent's CD) for monitoring call activities. The submission can be periodic or upon request of the first CD 102. In the latter embodiment, the request can be transmitted over the air to the second CD 102 as an SMS message.

If a submission of the communication log is not required, the second CD 102 proceeds to step 310 and continues to monitor communication events after the previous communication session has terminated. Otherwise, the second CD 102 proceeds to step 324 where it submits the communication log to the first CD 102 as an SMS message or other communication format suitable for presentation at the first CD 102 by way of UI 204 in step 326. The communication log can be organized to provide a tally of activities per entry. From this presentation, the user (e.g., parent) of the first CD 102 can decide whether an adjustment to the portion of the contact book previously submitted to the second CD 102 is warranted. One reason for changing the programming might be that the child is abusing the exception option (step 314) for particular entries. To address this, the parent can remove the entries at issue from the child's contact book for a period of time until the parent feels the child can act responsibly. Once an adjustment is made in step 328 and detected in step 330, the first CD 102 proceeds to step 306 where it submits the updated portion of the contact book to the second CD to update its programming. Otherwise, the second CD 102 continues monitoring communication requests in step 310.

Method 400 describes a voicemail process that supplements the communication processing embodiments of method 300. In step 402, the voicemail (VM) system 112 receives a call from a calling party that was unable to reach the second CD 102 (i.e., child's phone). In step 404, the VM system 112 records a voicemail message utilizing common means. The VM system 112 in step 406 can be programmed to notify the second CD 102 that a voicemail message has been recorded by for example signaling over the air the second CD to highlight a voicemail icon in UI 204. A similar notification can be submitted to the first CD in step 408. The user of the second CD 102 can access the VM system 112 by dialing for example the same phone number as has been assigned to the second CD. In step 410, the VM system 112 can be programmed to present the voicemail recording to the user of the second CD 102. The user of the first CD 102 can also listen to the voicemail message using the same process without the user of the second CD knowing that voicemail recordings are being monitored.

In step 412, the VM system 112 can be programmed to accept a deletion request from an authorized party (e.g., user of the first CD 102) and reject the same request from restricted parties (e.g., user of the second CD). This embodiment can be useful in the parent-child scenario. That is, the parent can prevent deletions by the child so that the parent has time to review voicemail messages directed to the child. If the parent makes a proactive request to delete one or more voicemail messages, the VM system 112 proceeds to step 414 where it deletes the selected messages. If a deletion request is made by the child, the VM system 112 proceeds to step 416 where it generates an error message indicating to the child that s/he is not authorized to make deletions.

In either case, the VM system 112 can also be programmed to check in step 418 for scheduled purging. For example, messages more than 3 days old can be scheduled to be purged. If messages are to be purged, the VM system 112 proceeds to step 420. Otherwise, method 400 ends and is repeated for other voicemail recordings.

From the foregoing descriptions, it would be evident to an artisan with ordinary skill in the art that the aforementioned embodiments can be modified, reduced, or enhanced without departing from the scope and spirit of the claims described below. For example, the terms “first” and “second” CD as used in the present disclosure are interchangeable. Method 300 can be supplemented so that the user of the second CD 102 is prevented from making alterations to the partial contact book received from the first CD. The communication log can also include partial voice or data recordings of the communication exchanges acted on by the user of the second CD 102. These are but a few examples of how the embodiments described herein can be updated without altering the scope of the claims below. Accordingly, the reader is directed to the claims for a fuller understanding of the breadth and scope of the present disclosure.

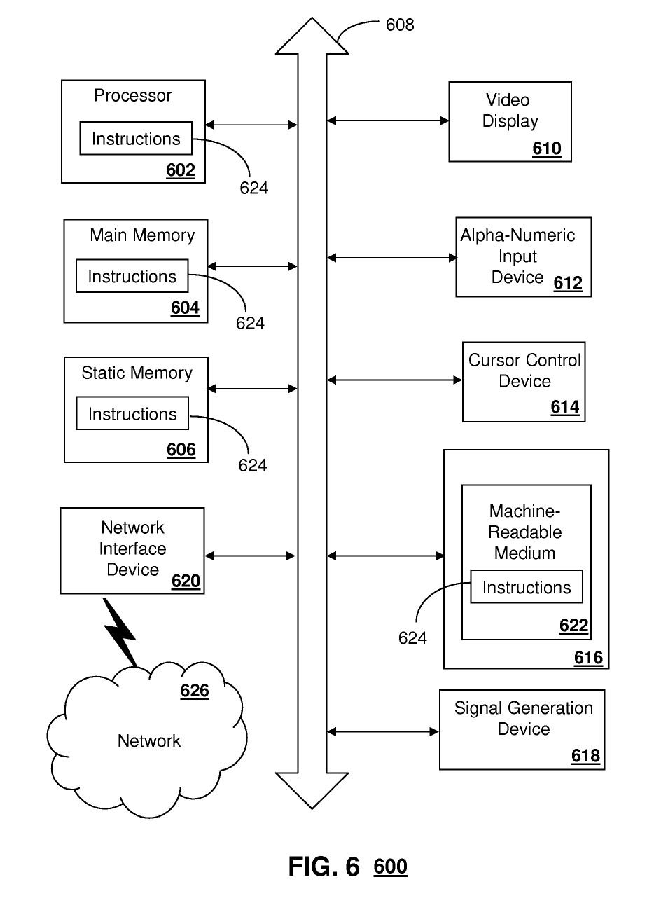

FIG. 6 depicts an exemplary diagrammatic representation of a machine in the form of a computer system 600 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 600 may include a processor 602 (e.g., a central processing unit (CPU), a graphics processing unit (GPU, or both), a main memory 604 and a static memory 606, which communicate with each other via a bus 608. The computer system 600 may further include a video display unit 610 (e.g., a liquid crystal display (LCD), a flat panel, a solid state display, or a cathode ray tube (CRT)). The computer system 600 may include an input device 612 (e.g., a keyboard), a cursor control device 614 (e.g., a mouse), a disk drive unit 616, a signal generation device 618 (e.g., a speaker or remote control) and a network interface device 620.

The disk drive unit 616 may include a machine-readable medium 622 on which is stored one or more sets of instructions (e.g., software 624) embodying any one or more of the methodologies or functions described herein, including those methods illustrated above. The instructions 624 may also reside, completely or at least partially, within the main memory 604, the static memory 606, and/or within the processor 602 during execution thereof by the computer system 600. The main memory 604 and the processor 602 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium in a communication device, comprising computer instructions for:
creating a contact book with a plurality of entries in the communication device;
classifying a portion of the plurality of entries of the contact book for use by a second communication device; and
submitting to the second communication device the portion of the plurality of entries of the contact book, wherein a scope of communications of the second communication device is limited to the portion of the plurality of entries of the contact book.

2. The storage medium of claim 1, comprising computer instructions for:
modifying a field in at least one of the plurality of entries of the contact book with a marker that identifies the second communication device; and
classifying the portion of the plurality of entries of the contact book from the at least one of the plurality of entries comprising the marker.

3. The storage medium of claim 1, wherein each of the plurality of entries stores a name of a party and at least one among a plurality of communication identifiers of the party.

4. The storage medium of claim 3, wherein the plurality of communication identifiers comprise one or more telephone numbers, one or more email addresses, one or more instant messaging addresses, one or more Internet addresses, and a communication preference for communicating with the party.

5. The storage medium of claim 4, wherein the communication preference comprises an option to direct the second communication device to only receive incoming messages associated with one of the communication identifiers of the party, only transmit outgoing messages to one of the communication identifies of the party, or both.

6. The storage medium of claim 1, wherein the second communication device can only respond to a communication request having a communication identifier that is identified in the portion of the plurality of entries, wherein the communication request comprises at least one among a telephone call, an email, and an instant messaging request.

7. The storage medium of claim 1, comprising computer instructions for receiving a communication log from the second communication device, wherein the communication log comprises one or more communication identifiers associated with the portion of the plurality of entries of the contact book.

8. The storage medium of claim 7, comprising computer instructions for identifying from the communication log a tally of communication sessions for each entry in the portion of the plurality of entries of the contact book.

9. The storage medium of claim 1, comprising computer instructions for:
receiving an update to the portion of the plurality of entries of the contact book; and
submitting the updated portion to the second communication device, wherein the scope of communications of the second communication device is limited to the updated portion.

10. A first communication device, comprising a controller element to:
receive one or more entries in a contact book of a second communication device; and
limit a scope of communications with other communication devices according to the one or more contact book entries received.

11. The first communication device of claim 10, wherein the controller element recognizes an exception to the scope of communications for a communication identifier associated with an emergency response center.

12. The first communication device of claim 10, wherein each of the one or more entries comprises a name of a party and at least one among a plurality of communication identifiers of the party.

13. The first communication device of claim 12, wherein the plurality of communication identifiers comprise one or more telephone numbers, one or more email addresses, one or more instant messaging addresses, one or more Internet addresses, and a communication preference for communicating with the party.

14. The first communication device of claim 13, wherein the controller element retrieves the communication preference of each of the one or more entries to determine the scope of communications for each of said entries, and wherein the communication preference comprises an option to direct the first communication device to only receive incoming messages associated with one of the communication identifiers of the party, only transmit outgoing messages to one of the communication identifies of the party, or both.

15. The first communication device of claim 10, wherein the controller element:
generates a communication log comprising information collected for each of one or more communication sessions associated with one or more communication identifiers in the one or more entries received from the second communication device; and
transmits the communication log to the second communication device.

16. The first communication device of claim 10, wherein the one or more entries of the contact book comprise a communication schedule for enabling communications.

17. A voicemail system, comprising a controller element to record one or more voicemail messages based on a call redirected from an unresponsive first communication device having a limited scope of communications with other communication devices defined by a portion of a contact book of a second communication device supplied to the first communication device.

18. The voicemail system of claim 17, wherein the controller element records the one or more voicemail messages of the first communication device in a voicemail account accessible by a user of the second communication device.

19. The voicemail system of claim 18, wherein controller element:
prevents a user of the first communication device from deleting one or more of the recorded one or more voicemail messages;
presents responsive to a request by the user of the first communication device an audio signal of a select one of the recorded one or more voicemail messages; and
deletes responsive to a request by the user of the second communication device one or more of the recorded one or more voicemail messages.

20. The voicemail system of claim 18, wherein the controller element configures the voicemail account according to a directive given by the user of the second communication device.

21. The voicemail system of claim 18, wherein the controller element configures the voicemail account to accept voicemail messages according to a schedule given by the user of the second communication device.
